(19) United States
(12) Patent Application Publication
(10) Pub. No.: US 2022/0079118 A1
(43) Pub. Date: Mar. 17, 2022

(54) ADJUSTABLE OR MODULAR NECKWEAR

(71) Applicant: Dillon David Porter, Salt Lake City, UT (US)

(72) Inventor: Dillon David Porter, Salt Lake City, UT (US)

(21) Appl. No.: 17/463,487

(22) Filed: Aug. 31, 2021

Related U.S. Application Data
(60) Provisional application No. 63/077,506, filed on Sep. 11, 2020.

(51) Int. Cl. A01K 27/00; A01K 15/02

(52) U.S. Cl. CPC A01K 27/001; A01K 15/023; A01K 27/003; A01K 27/006; A01K 27/009; A01K 27/005

(57) ABSTRACT

A collar includes a first portion and a second portion. The first portion includes a first material strip having a first end and an opposing second end, a first connector coupled to the first end, and a second connector coupled to the opposing second end. The second portion includes a second material strip having a third end and an opposing fourth end, a third connector coupled to the third end, and a fourth connector coupled to the opposing fourth end. The first connector is configured to selectively engage with the third connector and the second connector is configured to selectively engage with the fourth connector to facilitate selectively coupling the first portion and the second portion together.

### CROSS-REFERENCE TO RELATED PATENT APPLICATION

This application claims the benefit of and priority to U.S. Provisional Patent Application No. 63/077,506, filed Sep. 11, 2020, which is incorporated herein by reference in its entirety.

### BACKGROUND

Commercially available collars have either a single connection point or zero connection points (i.e., a continuous loop). For example, a collar with zero connection points can be loosened to put on and then tightened to the appropriate size. As another example, a collar with a single connection point can be unconnected at the connection point, put on, and then reconnected at the connection point. In both instances, the collar is one piece that cannot have a portion thereof changed or swapped.

### SUMMARY

One embodiment relates to a collar. The collar includes a first portion and a second portion. The first portion includes a first material strip having a first end and an opposing second end, a first connector coupled to the first end, and a second connector coupled to the opposing second end. The second portion includes a second material strip having a third end and an opposing fourth end, a third connector coupled to the third end, and a fourth connector coupled to the opposing fourth end. The first connector is configured to selectively engage with the third connector and the second connector is configured to selectively engage with the fourth connector to facilitate selectively coupling the first portion and the second portion together.

Another embodiment relates to a collar kit. The collar kit includes a first collar portion, a second collar portion, and a third collar portion. The first collar portion and the second collar portion are selectively couplable to form a first collar. The third collar portion is (i) selectively couplable to the first collar and the second collar portion or (ii) selectively interchangeable with the first collar portion or the second collar portion to form a second collar.

Another embodiment relates to a lanyard. The lanyard includes a material loop, a connector, and an adjuster. The material loop has a first end and an opposing second end. The material loop has a seam positioned between the first end and the opposing second end to separate the material loop into (i) a first loop defined between the first end and the seam and (ii) a second loop defined between the seam and the opposing second end. The connector is coupled to the first loop. The adjuster is coupled to the material loop between the seam and the opposing second end. The adjuster is configured to facilitate adjusting a size of the second loop.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a modular collar, according to an exemplary embodiment.

FIG. 2 is a detailed view of a first portion of the modular collar of FIG. 1, according to an exemplary embodiment.

FIG. 3 is a detailed view of a second portion of the modular collar of FIG. 1, according to an exemplary embodiment.

FIG. 4 is a detailed view of a lanyard in a first configuration, according to an exemplary embodiment.

FIG. 5 is a detailed view of the lanyard of FIG. 4 in a second configuration, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Collar

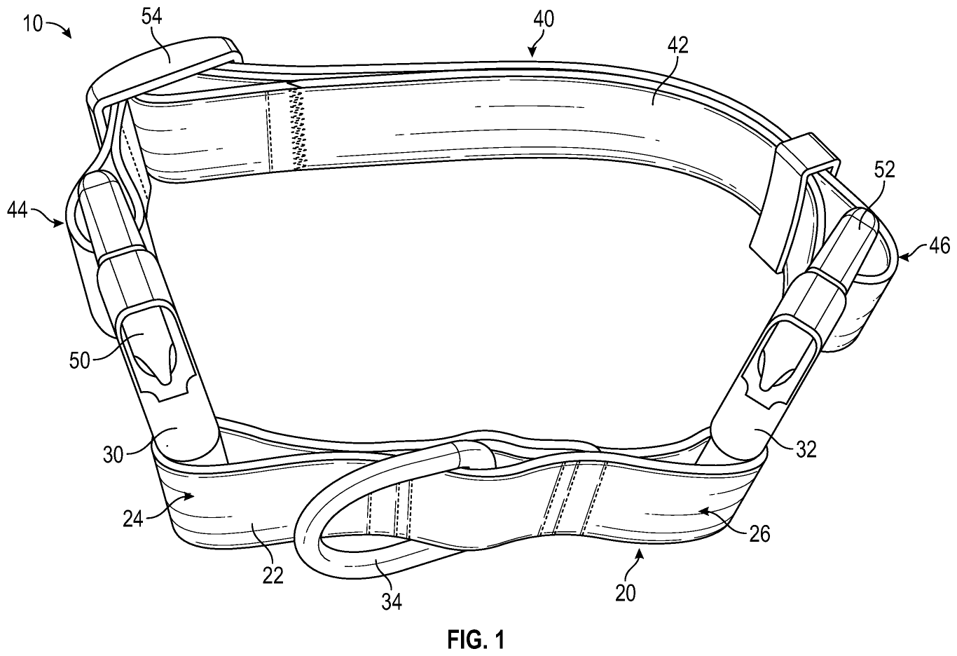

According to the exemplary embodiment shown in FIGS. 1-3, a modular or interchangeable neckwear or pet collar, shown as collar 10, has a multi-piece (e.g., two-piece, etc.) arrangement or construction that connects and disconnects at multiple (e.g., two, etc.) connection points. As shown in FIG. 1, the collar 10 includes a first portion or piece, shown as first collar portion 20, and a second portion or piece, shown as second collar portion 40, coupled to the first collar portion 20 to form the collar 10. While described herein as including two collar portions, it should be understood the collar 10 can include three or more collar portions (as desired by the pet owner). The three or more portions can be similarly coupled together to form a single collar (e.g., a larger collar, a collar with three or more features, etc.).

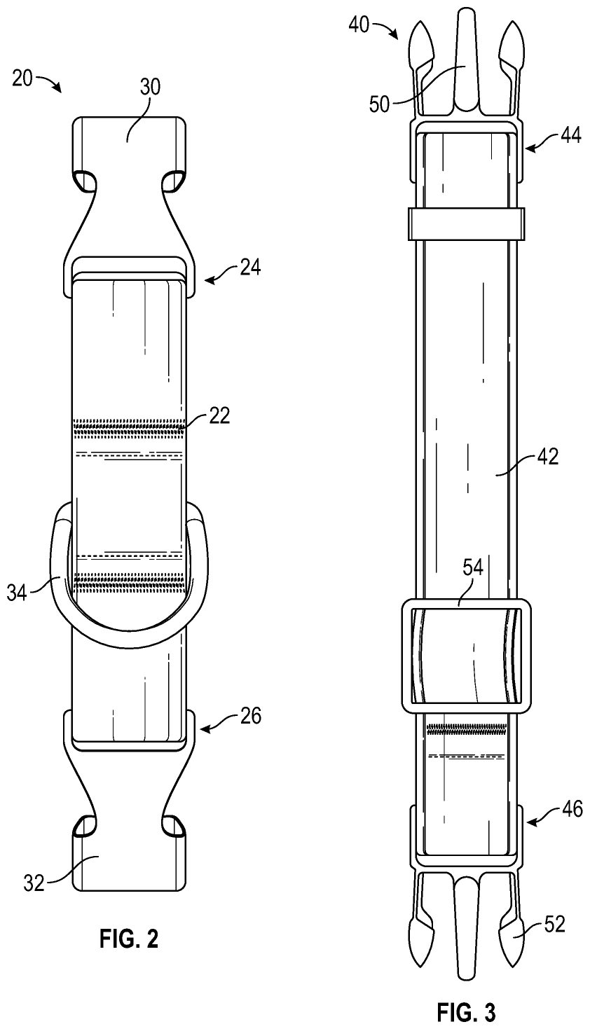

As shown in FIGS. 1 and 2, the first collar portion 20 has a first material portion, shown as material strip 22, having a first end, shown as first connection end 24, and an opposing second end, shown as second connection end 26. The first connection end 24 has a first coupler, shown as first connector 30, coupled (e.g., secured, attached, etc.) thereto. The second connection end 26 has a second coupler, shown as second connector 32, coupled (e.g., secured, attached, etc.) thereto.

As shown in FIGS. 1 and 3, the second collar portion 40 has a second material portion, shown as material strip 42, having a first end, shown as third connection end 44, and an opposing second end, shown as fourth connection end 46. The third connection end 44 has a third coupler, shown as third connector 50, coupled (e.g., secured, attached, etc.) thereto. The fourth connection end 46 has a fourth coupler, shown as fourth connector 52, coupled (e.g., secured, attached, etc.) thereto.

As shown in FIG. 1, (i) the first connector 30 is configured to engage with the third connector 50 to facilitate selectively coupling the first connection end 24 of the first collar portion 20 to the third connection end 44 of the second collar portion 40 and (ii) the second connector 32 is configured to engage with the fourth connector 52 to facilitate selectively coupling the second connection end 26 of the first collar portion 20 to the fourth connection end 46 of the second collar portion 40 to form the collar 10. According to the exemplary embodiment shown in FIGS. 1-3, the first connector 30 and the second connector 32 are female connectors and the third connector 50 and the fourth connector 52 are male connectors. In another embodiment, the first connector 30 and the second connector 32 are male connectors and the third connector 50 and the fourth connector 52 are female connectors. In still another embodiment, (i) one of the first connector 30 and the second connector 32 is a female connector and the other of the first connector 30 and the second connector 32 is a male connector and (ii) one of the third connector 50 and the fourth connector 52 is a female connector and the other of the third connector 50 and the fourth connector 52 is a male connector. According to the exemplary embodiment shown in FIGS. 1-3, the first connector 30, the second connector 32, the third connector 50, and the fourth connector 52 are contoured side release buckles. In other embodiments, another type of buckle is used. In still other embodiments, other suitable couplers are used. In some embodiments, the first connector 30 and the third connector 50 are a first type of connectors and the second connector 32 and the fourth connector 52 are a second, different type of connectors.

As shown in FIGS. 1-3, the first collar portion 20 includes a first feature, shown as collar feature 34, and the second collar portion 40 includes a second feature, shown as collar feature 54. According to the exemplary embodiment shown in FIGS. 1-3, the collar feature 34 is different than the collar feature 54. In some embodiments, the collar feature 34 and the collar feature 54 are the same. In some embodiments, one of the first collar portion 20 does not include the collar feature 34 or the second collar portion 40 does not include the collar feature 54.

As shown in FIGS. 1 and 2, the collar feature 34 is a ring (e.g., a D-ring, etc.) that facilitates coupling tags (e.g., identification tags, rabies tags, park permission tags, etc.) and/or a leash to the collar 10. In some embodiments, the collar feature 34 is a leash integrated with the material strip 22 (e.g., the material strip 22 and the leash are a single piece of material, the leash is sewn or otherwise secured to the material strip 22, etc.). In some embodiments, the collar feature 34 is a battery-operated light. In some embodiments, the collar feature 34 is a vibrational element (e.g., a vibrator, etc.), a shock element (e.g., an electric shocker, etc.), and/or an audible element (e.g., a speaker, etc.). In some embodiments, the collar feature 34 is a GPS tracker and/or a cellular chip. In some embodiments, the collar feature 34 is an adjustable slide (e.g., a triglide slide, etc.) that facilitates selectively adjusting the length of the first collar portion 20 and, thereby, the diameter of the collar 10. In some embodiments, the length of the first collar portion 20 is non-adjustable (i.e., fixed length). In such instances, the first collar portion 20 may be manufactured in various lengths to facilitate replacing a shorter first collar portion 20 with a longer first collar portion 20 to facilitate adjusting the diameter of the collar 10. In some embodiments, the collar feature 34 includes two or more of the listed features.

As shown in FIGS. 1 and 3, the collar feature 54 is an adjustable slide (e.g., a triglide slide, etc.) that facilitates selectively adjusting the length of the second collar portion 40 that facilitates selectively adjusting the length of the second collar portion 40 and, thereby, the diameter of the collar 10. In some embodiments, the second collar portion 40 is non-adjustable (i.e., fixed length). In such instances, the second collar portion 40 may be manufactured in various lengths to facilitate replacing a shorter second collar portion 40 with a longer second collar portion 40 to facilitate adjusting the diameter of the collar 10. In some embodiments, the collar feature 54 is a ring (e.g., a D-ring, etc.) that facilitates coupling tags (e.g., identification tags, rabies tags, park permission tags, etc.) and/or a leash to the collar 10. In some embodiments, the collar feature 54 is a leash integrated with the material strip 42 (e.g., the material strip 42 and the leash are a single piece of material, the leash is sewn or otherwise secured to the material strip 42, etc.). In some embodiments, the collar feature 54 is a battery-operated light. In some embodiments, the collar feature 54 is a vibrational element (e.g., a vibrator, etc.), a shock element (e.g., an electric shocker, etc.), and/or an audible element (e.g., a speaker, etc.). In some embodiments, the collar feature 54 is a GPS tracker and/or a cellular chip. In some embodiments, the collar feature 34 includes two or more of the listed features.

In some embodiments, the material strip 22 and the material strip 42 are manufactured from the same material, have the same pattern, and have the same color scheme. In some embodiments, the material strip 22 is manufactured from a different material, has a different pattern, and/or has a different color scheme than the material strip 42.

Accordingly, the first collar portion 20 and the second collar portion 40 provide great modularity and options to a pet owner in terms of colors, patterns, materials, diameter, and features of the collar 10 by combining the first collar portion 20 and the second collar portion 40 having the colors, patterns, materials, lengths, and features of the pet owner's choosing. For example, a pet owner may have the option to choose from (i) a plurality of first collar portions 20 having a variety of lengths, features, colors, and/or patterns and (ii) a plurality of second collar portions 40 having a variety of lengths, features, colors, and/or patterns. The pet owner can then select a respective first collar portion 20 from the plurality of first collar portions 20 and a respective second collar portion 40 from the plurality of second collar portions 40 based on the desired functionality, desired diameter, and/or desired color/pattern scheme of the collar 10 for their pet.

In addition, the multi-piece construction of the collar 10 allows a pet owner to replace only one portion of the collar 10 as necessary or as desired. By way of example, one of the first collar portion 20 or the second collar portion 40 may become damaged, torn, or worn out after a period of use by a pet. The pet owner may then purchase or obtain only the portion needed, rather than having to replace an entire collar.

In some instances, the collar 10 may be provided as a kit. By way of example, the kit may include a selected first collar portion 20, a selected second collar portion 40, and one or more replacement portions (e.g., a third collar portion, a fourth collar portion, etc.) for the selected first collar portion 20 and/or the selected second collar portion 40. In one example, the one or more replacement portions may be the same as the selected first collar portion 20 and/or the selected second collar portion 40. In another example, the one or more replacement portions may have varied lengths relative to the selected first collar portion 20 and/or the selected second collar portion 40 (e.g., to facilitate increasing or decreasing the diameter of the collar 10, etc.). In still another example, the one or more replacement portions may have different colors and/or patterns than the selected first collar portion 20 and/or the selected second collar portion 40. In yet another example, the one or more replacement portions may have different features than the collar feature 34 of the selected first collar portion 20 and/or the collar feature 54 of the selected second collar portion 40.

### Lanyard

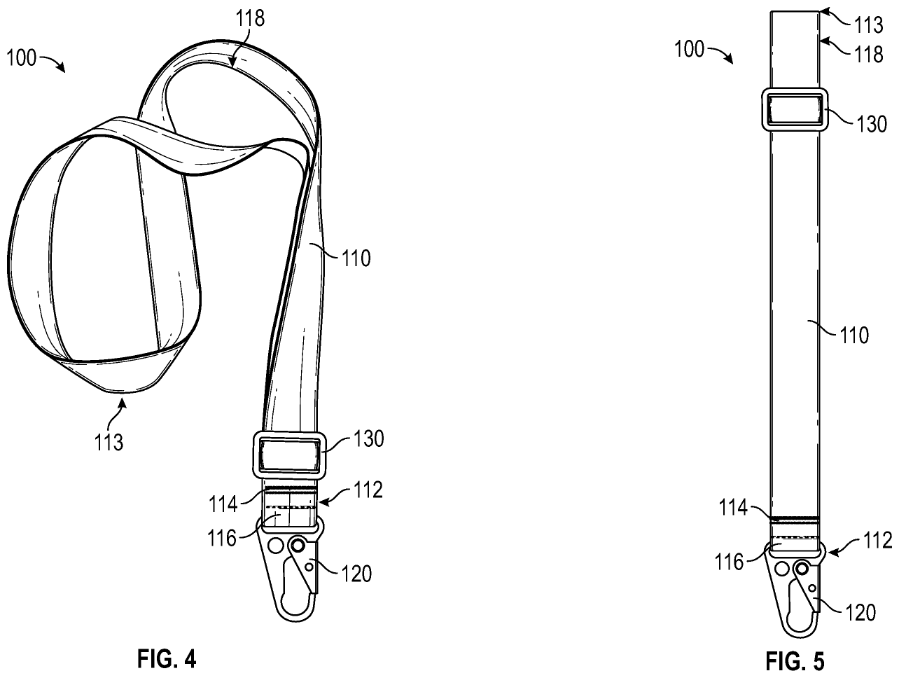

According to the exemplary embodiment shown in FIGS. 4 and 5, an adjustable neckwear or lanyard, shown as lanyard 100, has an adjustable arrangement that facilitates selectively enlarging and reducing the size of a neck loop of the lanyard 100 as desired. As shown in FIGS. 4 and 5, the lanyard 100 includes a material portion or material loop (e.g., strip of material, a cord, fabric, etc.), shown as lanyard webbing 110, having a first end, shown as clip end 112, and an opposing second end, shown as neck end 113. The lanyard webbing 110 may be formed by joining two free ends of the lanyard webbing 110 together to form a loop.

As shown in FIGS. 4 and 5, the lanyard 100 includes a seam, shown as seam 114, positioned between the clip end 112 and the neck end 113. According to an exemplary embodiment, the seam 114 is formed by sewing the front and rear portions of the lanyard webbing 110 together. In other embodiments, the seam 114 is formed using adhesive, an ultrasonic welding process, a heating process, and/or still another suitable process. As shown in FIGS. 4 and 5, the seam 114 is positioned a distance from an ultimate edge of the clip end 112 of the lanyard webbing 110 such that the loop of the lanyard 100 is separated or divided into two loops including (i) a first loop, shown as connector loop 116, formed between the ultimate end of the clip end 112 and the seam 114 and (ii) a second loop, shown as neck loop 118, formed between the seam 114 and the neck end 113. The connector loop 116 facilitates coupling or securing a fastener (e.g., a ring, a hook, a clip, a clasp, a connector, magnets, hook and loop fastener, etc.), shown as lanyard connector 120, thereto. The neck loop 118 is configured to fit over a wearer's head such that the lanyard 100 can rest around the wearer's neck.

As shown in FIGS. 4 and 5, the lanyard 100 includes an adjuster, shown as size adjuster 130, positioned along the lanyard webbing 110 between the seam 114 and the neck end 113 of the lanyard 100. The size adjuster 130 is configured to variably slide along the lanyard webbing 110 between the seam 114 and the neck end 113 facilitate infinitely adjusting (e.g., enlarging, reducing, etc.) the size of the neck loop 118 based on the wearer's preference. According to an exemplary embodiment, the size adjuster 130 is a tri-glide adjuster. In other embodiments, another suitable adjuster is used.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

It is important to note that the construction and arrangement of the collar 10, the lanyard 100, and the components thereof as shown in the various exemplary embodiments is illustrative only. Additionally, any element disclosed in one embodiment may be incorporated or utilized with any other embodiment disclosed herein.

1. A collar comprising:
a first portion including:
a first material strip having a first end and an opposing second end;
a first connector coupled to the first end; and
a second connector coupled to the opposing second end; and
a second portion including:
a second material strip having a third end and an opposing fourth end;
a third connector coupled to the third end; and
a fourth connector coupled to the opposing fourth end;
wherein the first connector is configured to selectively engage with the third connector and the second connector is configured to selectively engage with the fourth connector to facilitate selectively coupling the first portion and the second portion together.

2. The collar of claim 1, wherein the first material strip is manufactured from a first material and the second material strip is manufactured from a second material that is different than the first material.

3. The collar of claim 1, wherein the first material strip has a first length and the second material strip has a second length that is different than the first length.

4. The collar of claim 3, wherein the first length is fixed and the second length is adjustable.

5. The collar of claim 1, wherein the first material strip has a first color or pattern and the second material strip has a second color or pattern that is different than the first color or pattern.

6. The collar of claim 1, wherein the first material strip has a first feature and the second material strip has a second feature.

7. The collar of claim 6, wherein the first feature and the second feature each include at least one of (a) a ring that facilitates coupling at least one of a tag or a leash to the collar, (b) an adjustable slide that facilitates selectively adjusting a diameter of the collar, (c) an integrated leash, (d) a light, (e) a vibrational element, (f) a shock element, (g) an audible element, (h) a GPS tracker, or (i) a cellular chip.

8. The collar of claim 7, wherein the first feature is the same as the second feature.

9. The collar of claim 7, wherein the first feature is different than the second feature.

10. The collar of claim 9, wherein the first feature includes the ring, and wherein the second feature includes the adjustable slide.

11. A collar kit comprising:
a first collar portion;
a second collar portion; and
a third collar portion;
wherein the first collar portion and the second collar portion are selectively couplable to form a first collar; and
wherein the third collar portion is (i) selectively couplable to the first collar and the second collar portion or (ii) selectively interchangeable with the first collar portion or the second collar portion to form a second collar.

12. The collar kit of claim 11, wherein the second collar portion has a first length and the third collar portion has a second length such that interchanging the third collar portion for the second collar portion provides the second collar having a size that is different than the first collar, wherein the first length is fixed or adjustable and the second length is fixed or adjustable.

13. The collar kit of claim 11, wherein the first collar portion has a first material, a first length, a first color or pattern, and a first feature, wherein the second collar portion has a second material, a second length, a second color or pattern, and a second feature, and wherein at least one of the first material, the first length, the first color or pattern, or the first feature is different than the second material, the second length, the second color or pattern, or the second feature.

14. The collar kit of claim 13, wherein the third collar portion is different than the first collar portion and the second collar portion.

15. The collar kit of claim 13, wherein the third collar portion is the same as the first collar portion.

16. The collar kit of claim 13, wherein at least two of the first material, the first length, the first color or pattern, or the first feature are different than the second material, the second length, the second color or pattern, or the second feature.

17. The collar kit of claim 16, wherein at least three of the first material, the first length, the first color or pattern, or the first feature are different than the second material, the second length, the second color or pattern, or the second feature.

18. The collar kit of claim 13, wherein the first length is different than the second length.

19. The collar kit of claim 13, wherein the first feature and the second feature each include at least one of (a) a ring, (b) an adjustable slide, (c) an integrated leash, (d) a light, (e) a vibrational element, (f) a shock element, (g) an audible element, (h) a GPS tracker, or (i) a cellular chip, and wherein the first feature is different than the second feature.

20. A lanyard comprising:
a material loop having a first end and an opposing second end, the material loop having a seam positioned between the first end and the opposing second end to separate the material loop into (i) a first loop defined between the first end and the seam and (ii) a second loop defined between the seam and the opposing second end;
a connector coupled to the first loop; and
an adjuster coupled to the material loop between the seam and the opposing second end, the adjuster configured to facilitate adjusting a size of the second loop.
